(19) United States
(12) Patent Application Publication
(10) Pub. No.: US 2015/0047494 A1
(43) Pub. Date: Feb. 19, 2015

(54) PORTABLE MUSICAL KEYBOARD INSTRUMENT

(71) Applicant: Kathleen Frances Cronin, Weymouth, MA (US)

(72) Inventor: Kathleen Frances Cronin, Weymouth, MA (US)

(21) Appl. No.: 13/969,374

(22) Filed: Aug. 16, 2013

(51) Int. Cl. G10H 1/00

(52) U.S. Cl. CPC G10H 1/0008
USPC 84/609

(57) ABSTRACT

Embodiments provide a portable musical instrument including an electronic musical keyboard and a monitor. The monitor is rotatably coupled to the musical keyboard such that the monitor has a use position and a storage position. In use position, the monitor forms an angle of at least about 90 degrees with respect to the musical keyboard. Embodiment of the musical keyboard includes less than three and more than one octave of keys, each key approximately corresponds in size, shape, frequency, and weight to a conventional piano key. The musical keyboard is configured to produce a signal characterizing the depression of any its keys. The monitor visually displays piano staffs and musical notations, which musical notations may be derived from the signal produced by the musical keyboard. In some embodiments, a printing device may print, on paper, musical notations derived from the signal produced by the musical keyboard.

### TECHNICAL FIELD

Exemplary embodiments relate to portable musical keyboard instruments.

### SUMMARY

The present invention is a portable musical keyboard instrument. A goal of the present invention was to stimulate beginning musicians to practice and create their own music. An exemplary keyboard instrument is configured to enable individual piano learners to play simple pieces of music and build finger skill, strength, and dexterity through practice. Since the keys of the keyboard approximately correspond to piano keys in all aspects, playing music with this invention simulates the experience of playing a conventional piano. The present invention enables users to improvise simple pieces of music and may also enable users to view and/or print corresponding musical notations corresponding to the depression of any keys of the musical keyboard.

One embodiment features a musical keyboard and a monitor. The musical keyboard in accordance with the invention consists of less than three and more than one octave of keys. Exemplary musical keyboards in accordance with the invention may consist of two octaves of keys. Exemplary musical keyboards in accordance with the invention may consist of a total of twenty-five keys. Each of the keys in the keyboard of the invention approximately corresponds in shape, size, frequency and weight to a conventional piano key. The musical keyboard is configured to produce an audio signal that includes a description of a depression of any of its keys in the keyboard of the invention. The monitor is configured to display piano staffs and musical notation corresponding to the depression of any of the keys of the keyboard, which may be derived from the audio signal produced by the musical keyboard. The monitor is coupled to the musical keyboard and would be able to rotate such that the monitor has a use position in which it forms an angle of at least about 90 degrees with respect to the keyboard and a storage position in which the monitor covers the musical keyboard to form a portable unit.

Another embodiment features a musical keyboard, a monitor, and a printer. The musical keyboard in accordance with the invention consists of less than three and more than one octave of keys. Exemplary musical keyboards in accordance with the invention may consist of two octaves of keys. Exemplary musical keyboards in accordance with the invention may consist of a total of twenty-five keys. Each of the keys in the keyboard of the invention approximately corresponds in size, shape and weight to a conventional piano key. The musical keyboard is configured to produce a signal including a description of depression of any key in the keyboard of the invention. The monitor is configured to display piano staffs and musical notation. The musical notation displayed by the monitor may be derived from the signal produced by the musical keyboard. The printer is configured to print musical notation corresponding to the signal produced by the musical keyboard. The monitor is rotatably coupled to the musical keyboard such that the monitor has a use position in which the monitor forms an angle of at least about 90 degrees with respect to the keyboard and a storage position in which the monitor covers the musical keyboard and forms a portable unit including the musical keyboard and the printer.

In some aspects of either of the foregoing embodiments, the at least one speaker is configured to receive the audio signal from the musical keyboard and produce sound.

In some aspects of either of the foregoing embodiments, the portable musical instrument may further include a mechanism for adjusting the volume of the at least one speaker.

In some aspects of either of the foregoing embodiments, the portable musical instrument may further include a headphone port. The headphone port is configured to receive an audio signal from the musical keyboard.

In some aspects of either of the foregoing embodiments, the at least one speaker does not produce sound when a headphone connector is inserted in the headphone port.

In some aspects of either of the foregoing embodiments, the portable musical instrument may further include a mechanical device for holding sheet music such that it rests against the monitor while the monitor is in the use position.

In some aspects of either of the foregoing embodiments, the monitor is configured to begin displaying musical notation corresponding to the depression of any of the keys of the musical keyboard shortly after the depression.

In some aspects of either of the foregoing embodiments, the portable musical instrument may further include a memory device coupled to the musical keyboard. The memory device is configured to store a representation of a musical notation describing a depression of a key of the musical keyboard during and/or shortly after the depression.

In some aspects of either of the foregoing embodiments, the portable musical instrument may further include a printer coupled to the musical keyboard. The printer is configured to print a musical notation whose representation is stored in the memory device.

In some aspects of either of the foregoing embodiments, the portable musical instrument may further include a rechargeable battery electrically coupled to the monitor. The rechargeable battery is configured to power the portable musical instrument.

In some aspects of either of the foregoing embodiments, depression of any key of the musical keyboard requires approximately the same force as depression of a corresponding piano key.

Exemplary embodiments further provide one or more non-transitory computer-readable media having encoded thereon one or more computer-executable instructions that, when executed on an electronic keyboard computing system or device, perform any of the methods described herein.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 is a perspective view of an exemplary portable musical keyboard instrument.

FIG. 2 is a left side view of the exemplary keyboard instrument of FIG. 1.

FIG. 3 is a block diagram of exemplary components of an exemplary musical keyboard instrument.

FIG. 4 is a block diagram of an exemplary musical keyboard computing device.

The accompanying drawings are not intended to be drawn to scale.

### DETAILED DESCRIPTION

Exemplary embodiments of the portable musical instrument of the invention include an electronic musical keyboard and a monitor. The monitor is rotatably coupled to the musical keyboard such that the monitor has a use position and a storage position. In the use position, the monitor forms an angle of at least about 90 degrees with respect to the musical keyboard. In the storage position, the monitor covers the musical keyboard and forms a portable unit including the keyboard. The musical keyboard of the invention include less than three and more than one octave of keys. Each key of the musical keyboard approximately corresponds in size, shape, frequency, and weight to a conventional piano key. The musical keyboard of the invention is configured to produce one or more audio signals. In some embodiments of the instrument, the monitor may visually display piano staffs and musical notation corresponding to the depression of any of the keys of the musical keyboard as described in the audio signal produced by the musical keyboard. Some exemplary embodiments of the instrument further include a printing device. The printing device of these embodiments prints, on paper, musical notations corresponding to the audio signals from the keyboard.

The instrument of the present invention is portable and enables a user to play music anywhere free of the size and weight constraints of a conventional full-sized piano. Since the keys of the musical keyboard approximately correspond to piano keys in most if not all respects, playing music with this invention simulates the experience of playing a conventional piano. The musical instrument of the invention enables users of all ages to play music and to build skill, strength, and dexterity. The instrument also enables a user to create his/her own music. In some embodiments, the instrument enables the user to display, print, and/or record musical notations corresponding to the music played. The instrument may, for example, include a printer or printing device for printing the musical notations on paper and/or a computer-readable medium recorder (e.g., a USB port driver) for encoding a computer-readable medium with the musical notations.

The display and/or recording of the music played on the instrument may enable a user to understand his strengths and weaknesses. The display and/or recording of the music played on the instrument may also enable a user to compose music using the instrument without manually noting musical notations, which may break the flow of the composition.

Certain terms are defined in this section to facilitate understanding of exemplary embodiments.

The terms “equal” and “substantially equal,” as used herein, refer interchangeably, in a broad lay sense, to exact equality or approximate equality within some tolerance.

The terms “similar” and “substantially similar,” as used herein, refer interchangeably, in a broad lay sense, to exact sameness or approximate similarity within some tolerance.

The terms “couple,” “coupled” and “coupling,” as used herein, refer to a direct or indirect connection among two or more components. For example, a first component may be coupled to a second component directly or through one or more intermediate components.

The term “computer-readable medium,” as used herein, refers to a non-transitory storage hardware, non-transitory storage device or non-transitory computer system memory that may be accessed by a controller, a microcontroller, a computational system or a module of a computational system to encode thereon computer-executable instructions or software programs. The “computer-readable medium” may be accessed by a computational system or a module of a computational system to retrieve and/or execute the computer-executable instructions or software programs encoded on the medium. The non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM) and the like.

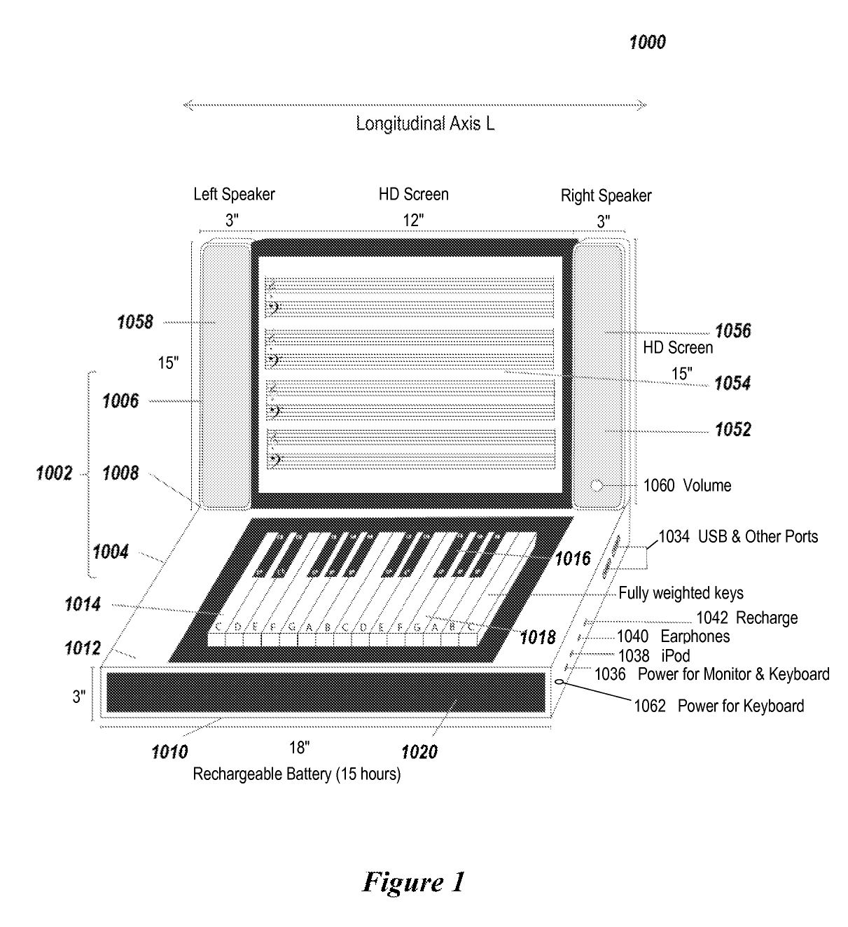

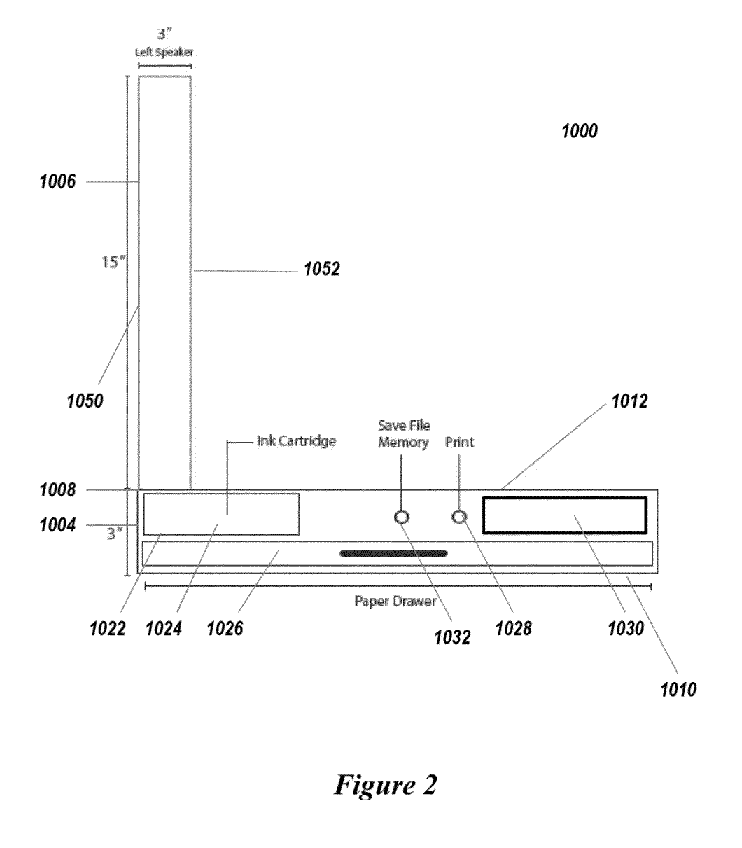

FIG. 1 is a perspective view of an exemplary musical keyboard instrument 1000 that is substantially in the form of a portable laptop computing device and is particularly configured to enable a user to play musical notes. FIG. 2 is a left side view of the exemplary keyboard instrument 1000. The instrument 1000 includes a solid exterior housing 1002 that, in turn, includes a base portion 1004 for accommodating a keyboard, a lid portion 1006 for accommodating a monitor, and a hinged portion 1008 rotatably coupling the base portion and the lid portion.

In one embodiment, the hinged portion 1008 may extend along a longitudinal axis L continuously or at discrete portions between the base portion 1004 and the lid portion 1006. The hinged portion 1008 enables rotatable movement between the base portion 1004 and the lid portion 1006 so that the base and lid may be moved toward each other or away from each other. For example, in a storage position, the lid portion may be closed over the base portion so that the monitor in the lid portion and keys in the keyboard in the base portion come close to each other. In use position, the lid and/or the base portion may be rotated about the hinged portion so that the inner surfaces of the lid and the base are spaced away from each other. The monitor may form an angle of at least about 90 degrees with respect to the musical keyboard in the use position.

In one embodiment, the base portion 1004 has a substantially flattened and hollow box-like structure, configuration and shape. The base portion 1004 includes a substantially flat rectangular lower surface 1010 that may be used to place the instrument 1000 on an external surface. The lower surface 1010 may have a non-skid surface including, for example, one or more textured and/or rubberized portions.

The base portion 1004 also includes an opposite upper surface 1012 that provides a musical keyboard 1014 protruding through and outside the upper surface 1012. Each musical key in the keyboard 1014 approximately corresponds in size, shape, frequency and weight to a conventional piano key. That is, the keys of the keyboard 1014 are fully weighted, i.e., depressing a key requires approximately the same force as a conventional piano key and has approximately the same resistance and “feel” as those of a conventional piano key. The keys of the keyboard 1014 have approximately the same feel as conventional piano keys. In some embodiments, the keys of the keyboard 1014 may be labeled for ease of use for novice music players. The keys of the keyboard 1014 are configured to generate one or more electronic audio signals when a user depresses them. The audio signals may be used to generate audio corresponding to the depression of the keys of the keyboard and to display musical notations on the monitor 1054 corresponding to the keys being depressed. The audio or sound generated by the instrument 1000 in response to a user depressing the keys are designed to sound like a conventional piano.

In some exemplary embodiments, the keyboard 1014 may approximately correspond to a subset of a full musical keyboard found on a conventional grand piano, i.e., one in which pressing a key causes a hammer to hit a particular string. In exemplary embodiments, the musical keyboard 1014 includes less than three and more than one octave of musical keys approximately corresponding to those of a conventional piano. In one exemplary embodiment, the musical keyboard 1014 may include two octaves of musical keys approximately corresponding to those of a conventional piano. In other exemplary embodiments, the musical keyboard 1014 may include two full octaves and part of one or more additional octaves of musical keys, for example, 1, 3, 4, 5, 6, 7, 8, 9, 10, or 11 additional keys.

In one exemplary embodiment in which the keyboard 1014 includes two octaves of musical keys, 25 musical keys are provided with 10 shorter keys (1016) and 15 longer keys (1018). The shorter and longer keys may be configured relative to one another in a similar configuration of keys on a grand piano. As on a conventional piano keyboard, the shorter keys may be raised above the level of the longer keys. The 15 longer keys 1018, from the left to the right, may correspond to the following sequence of musical notes: C, D, E, F, G, A, B, middle C, D, E, F, G, A, B, C. The 10 shorter keys 1018, from the left to the right, correspond to the following sequence of musical notes: C#/D^{b}, D#/E flat, F#/G^{b}, G#/A^{b}, A#/B^{b}, C#/D^{b}, D#/E^{b}, F#/G^{b}, G#/A^{b}, A#/B^{b}.

The interior hollow cavity of the base portion 1004 may be used to house one or more components of the instrument 1000 including, but not limited to, one or more rechargeable batteries 1020 for supplying power for the operation of the instrument. In some embodiments, the battery 1020 may supply power continuously for about 15 hours at a time without recharging. The battery 1020 does not need to be plugged into a power outlet during use of the instrument 1000.

In some embodiments, the cavity of the base portion 1004 may house a printing device 1022 including an ink cartridge 1024 for printing text (which may or may not include musical notations) on paper. The printing device 1022 includes a paper drawer 1026 for inserting paper into the printing device. The printing device 1022 also includes an activation button 1028 that, when pressed by a user, prints sheet music lines (i.e., staff) and the musical notations displayed on the monitor 1054 at the time. The paper inserted into the drawer 1026 may be blank paper (on which the printing device 1022 may print both the sheet music lines and the musical notations), or may have pre-printed musical sheet lines (on which the printing device 1022 may print only the musical notations). The printing device 1022 may be configured to accommodate paper of one or more suitable sizes, e.g., letter, A4, and the like.

In some embodiments, the cavity of the base portion 1004 may house a computer-readable medium recorder 1030, e.g., a CD drive. The recorder 1030 includes an activation button 1032 that, when pressed by a user, encodes the computer-readable medium with sheet music lines (i.e., staff) and the musical notations displayed on the monitor 1054 at that time. In some embodiments, the computer-readable medium recorder 1030 may also be configured to read computer-readable media, e.g., as a thumb drive, so that a computer-readable medium with musical notation encodings may be inserted into the recorder to display the recorded notations on the monitor 1054.

One or more side surfaces of the base portion 1004 may provide one or more ports 1034 for coupling the instrument 1000 to one or more external devices. These ports may include, for example, USB and/or other ports. One or more side surfaces of the base portion may provide a power switches, such as switch 1036 and switch 1062, so that one of more portions of the instrument may be connected to a power supply. Switch 1036, for example, may enable the monitor 1054 and/or printing device 1022 to be connected to or disconnected from the battery 1020. Switch 1062 may enable keyboard 1014 to be connected to or disconnected from the battery 1020. One or more side surfaces of the base portion may provide a mobile device port 1038 for coupling the instrument 1000 to an external mobile computing device (e.g., an iPod) so that data may be communicated between the instrument and the external device. One or more side surfaces of the base portion may provide a headphone port 1040 for coupling the instrument 1000 to an external audio device, e.g., earphones, headphones, so that audio generated by the instrument 1000 is emitted audibly using the external audio device. When an external device is plugged into the headphone port 1040, the instrument may only play music through the headphone port and may not play music using the audio speakers. One or more side surfaces of the base portion may provide a recharge port 1042 for coupling the instrument 1000 to an external power supply (e.g., an electrical outlet) so that the instrument may be operated on the external power and/or so that the battery 1020 may be recharged. The ports illustrated in FIG. 1 may also or alternatively be provided on one or more surfaces of the lid portion 1006.

In some embodiments, one or more side surfaces of the base portion 1004 may provide visual indicators for indicating one or more conditions or operational status of the instrument 1000, for example, whether the instrument is on/off, whether the battery of the instrument is recharging, whether the instrument is muted, and the like. The indicators illustrated in FIG. 1 may also or alternatively be provided on one or more surfaces of the lid portion 1006.

An exemplary length (along longitudinal axis L) of the base portion 1004 may range from about 12 inches to about 30 inches, but is not limited to this exemplary range. In some embodiments, the base portion 1004 has a length of about 15 inches to about 24 inches. In one exemplary embodiment, the base portion 1004 has a length of about 18 inches. An exemplary width of the base portion 1004 may range from about 4 inches to about 15 inches, but is not limited to this exemplary range. In some embodiments, the base portion 1004 has a width of about 6 inches to about 12 inches. In one exemplary embodiment, the base portion 1004 has a width of about 8 inches. An exemplary thickness of the base portion 1004 may range from about 1.0 inches to about 4 inches, but is not limited to this exemplary range. In some embodiments, the base portion 1004 has a thickness of about 1.5 inches to about 3 inches. In one exemplary embodiment, the base portion 1004 has a thickness of about 2 inches.

In one embodiment, the lid portion 1006 has a substantially flattened and hollow box-like structure, configuration and shape. The lid portion 1006 has a substantially flat rectangular upper surface 1050 and an opposite lower surface 1052 that provides a monitor or display screen 1054 that is viewable by a user when the instrument is in a use position. The monitor 1054 may use any suitable display technology including, but not limited to, high definition (HD), liquid crystal display (LCD), cathode ray tube (CRT), and the like. In some embodiments, the monitor 1054 is configured to display sheet music lines by default, i.e., when the monitor is first placed in its use position. The monitor 1054 is electronically coupled to the keyboard 1014 so that, when one or more keys on the keyboard are depressed, audio signals are generated by the keyboard and communicated to the monitor. The monitor 1054, in turn, displays, in conjunction with the sheet music lines, one or more musical notations corresponding to the keys that were depressed in real-time as the keys are being depressed. That is, the monitor 1054 displays the musical notations within a time period after the keys are depressed that is short enough to be perceived as simultaneous or concurrent with the depression of the keys by an average human user.

In some embodiments, the lower surface 1052 of the lid portion 1006 may also include one or more audio speakers 1056, 1058. In an exemplary embodiment, two audio speakers 1056, 1058 may be provided on either side of the monitor 1054, each speaker having an exemplary length of about 3 inches along the longitudinal axis L and an exemplary width of about 15 inches, although exemplary speakers are not limited to these exemplary ranges. An audio volume controller 1060 may be provided at or adjacent to an audio speaker 1056 for controlling the volume of the sound played by the audio speakers 1056, 1058. The audio speakers 1056, 1058 are electronically coupled to the keyboard 1014 so that, when one or more keys on the keyboard are depressed, audio signals are generated by the keyboard and communicated to the audio speakers. The audio speakers, in turn, generate sound corresponding to the audio signals in real-time as the keys are being depressed. That is, the audio speakers play the musical notes within a time period after the keys are depressed that is short enough to be perceived as simultaneous or concurrent with the depression of the keys by an average human user.

An exemplary length (along longitudinal axis L) of the lid portion 1006 may range from about 12 inches to about 30 inches, but is not limited to this exemplary range. In some embodiments, the lid portion 1006 has a length of about 15 inches to about 24 inches. In one exemplary embodiment, the lid portion 1004 has a length of about 18 inches. An exemplary width of the lid portion 1006 may range from about 4 inches to about 15 inches, but is not limited to this exemplary range. In some embodiments, the lid portion 1006 has a width of about 6 inches to about 12 inches. In one exemplary embodiment, the lid portion 1006 has a width of about 8 inches. An exemplary thickness of the lid portion 1006 may range from about 0.1 inches to about 3 inches, but is not limited to this exemplary range. In some embodiments, the lid portion 1006 has a thickness of about 0.5 inches to about 2 inches. In one exemplary embodiment, the lid portion 1006 has a thickness of about 1 inch.

The structure, shape, dimensions and weight of the instrument 1000 is configured so that the instrument is portable. An exemplary length of the instrument may range from about 12 inches to about 30 inches, but is not limited to this exemplary range. In some embodiments, the instrument has a length of about 15 inches to about 24 inches. In one exemplary embodiment, the instrument has a length of about 18 inches. An exemplary width of the instrument may range from about 4 inches to about 15 inches, but is not limited to this exemplary range. In some embodiments, the instrument has a width of about 6 inches to about 12 inches. In one exemplary embodiment, the instrument has a width of about 8 inches. In one embodiment, an exemplary instrument may have an exemplary length of about 15 inches and an exemplary width of about 10 inches. In the storage position, in which the lid portion 1006 is rotated to be close to the base portion 1004, an exemplary thickness of the instrument may range from about 1.5 inches to about 3.5 inches, but is not limited to this exemplary range. In some embodiments, the instrument in storage position has a thickness of about 2 inches to about 3 inches. In one exemplary embodiment, the instrument in storage position has a thickness of about 2.5 inches.

In some embodiments, the instrument 1000 may include a mechanical device, e.g., a stand, for holding physical sheet music so that the sheets rest against the monitor 1054 when the instrument is in the use position.

In some embodiments, a handle may be provided on an outer surface of the instrument 1000 so that a user may, for example, carry the instrument like a briefcase.

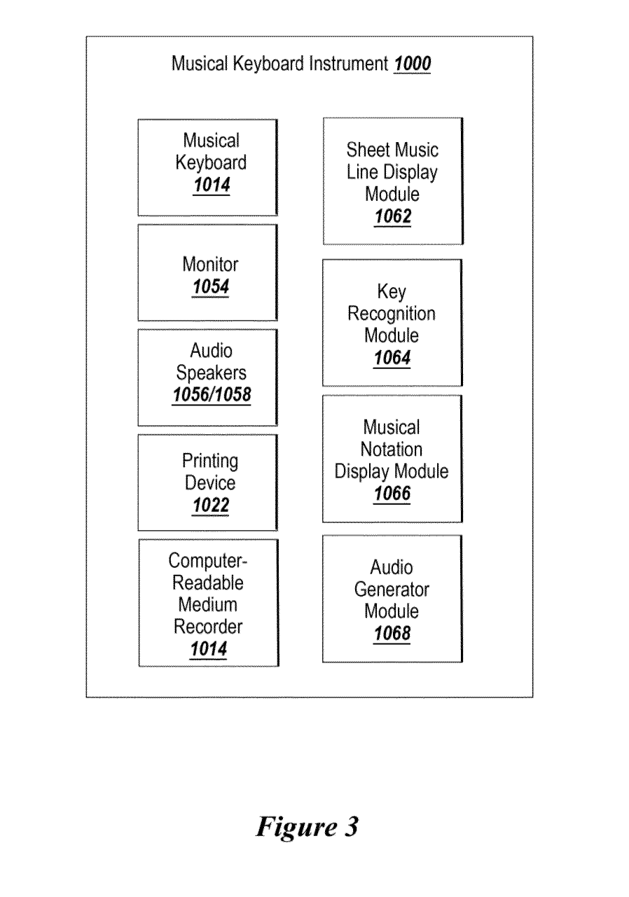

FIG. 3 is a block diagram of exemplary components of an exemplary musical keyboard computing device 1000 including an electronic musical keyboard 1014, a monitor 1054, audio speakers 1056, 1058, a printing device 1022 and a computer-readable medium recorder 1030.

The instrument 1000 includes a sheet music line display module 1062 that is programmed or configured to display piano staff or sheet music lines on the monitor 1054.

The instrument 1000 includes a key recognition module 1064 that is programmed or configured to automatically recognize the characteristics of the depression of any key(s) in the musical keyboard 1014 by a user and translate those characteristics into a signal.

The instrument 1000 includes a musical notation display module 1066 that is programmed or configured to display, on the sheet music lines rendered on the monitor, musical notations corresponding to the characteristics of the depression of keys as translated by the key recognition module 1064. The display may be triggered by playing the musical keyboard. Alternatively, the display may have to be turned on. As new keys are depressed, notations corresponding to the depression of new keys may also be displayed in conjunction with the previous keys displayed. That is, once activated, the display on the monitor 1054 is continually and automatically updated as keys are depressed on the keyboard 1014. The musical notations generated by the musical notation display module 1066 may be printed on paper using the printing device 1022 and/or may be recorded on a computer-readable medium using the computer-readable medium recorder 1014.

The instrument 1000 includes an audio generator module 1068 that is programmed or configured to generate audio signals from the signal produced by the key recognition module 1064. The audio generator module 1068 may include, for example, a database of audio samples corresponding to the possible characteristics of the depression of keys on the keyboard 1014. The audio signals may be used to play audio concurrently with the depression of keys on the keyboard 1014 using, for example, the audio speakers 1056/1058 of the instrument.

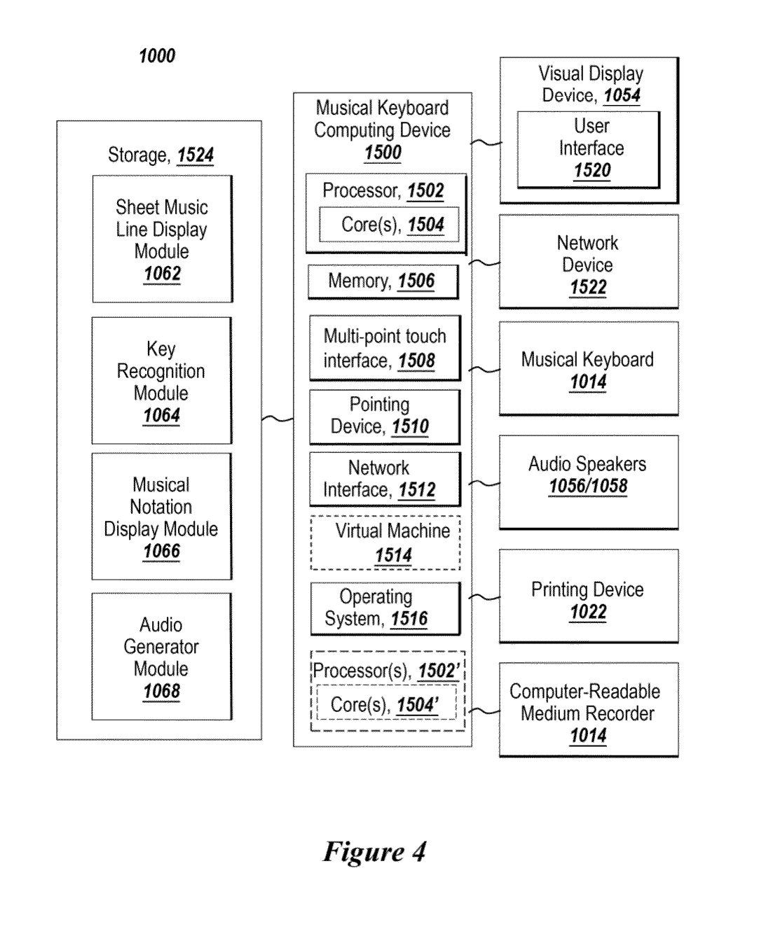

FIG. 4 is a block diagram of an exemplary keyboard instrument computing device 1500 that may be used to perform any of the methods or implement any of the systems and devices provided by exemplary embodiments. The computing device 1500 includes one or more non-transitory computer-readable media for storing one or more computer-executable instructions or software for implementing exemplary embodiments. The non-transitory computer-readable media may include, but are not limited to, one or more types of hardware memory, non-transitory tangible media, and the like. For example, memory 1506 included in the computing device 1500 may store computer-executable instructions or software for implementing exemplary embodiments. In one embodiment, memory 1506 may include a control module for storing computer-readable data and computer-executable instructions that implement and perform methods associated with controlling operation of one or more an exemplary musical keyboard instrument. In one embodiment, the memory 1506 may store the audio signals generated by the audio generator module 1068 and the musical notations generated by the musical notation display module 1066. Memory 1506 may include a computer system memory or random access memory, such as DRAM, SRAM, EDO RAM, and the like. Memory 1506 may include other types of memory as well, or combinations thereof.

The computing device 1500 includes processor 1502 and, optionally, one or more additional processor(s) 1502′ for executing computer-executable instructions or software stored in the memory 1506 and one or more other programs for controlling system hardware. Processor 1502 and optional processor(s) 1502′ may each be a single core processor or multiple core (1504 and 1504′) processor. Virtualization may be employed in the computing device 1500 so that infrastructure and resources in the computing device may be shared dynamically. A virtual machine 1514 may be provided to handle a process running on multiple processors so that the process appears to be using only one computing resource rather than multiple computing resources. Multiple virtual machines may also be used with one processor.

A user may interact with the computing device 1500 through a visual display device or monitor 1054, such as a computer monitor, which may display one or more user interfaces 1520 or any other interface. The user interface 1520 may display sheet music lines and musical notations corresponding to the keys depressed by a user on the keyboard 1014 of an exemplary musical keyboard instrument.

The computing device 1500 may include other I/O devices such a keyboard or a multi-point touch interface 1508 (the same as the musical keyboard 1014 or a different text keyboard) and a pointing device 1510, for example a mouse, for receiving input from a user. The keyboard 1508 and the pointing device 1510 may be connected to the visual display device 1054. The computing device 1500 may include other suitable conventional I/O peripherals. The computing device 1500 may also include a storage device 1524, such as a hard-drive, CD-ROM, or other computer readable media, for storing data and computer-readable instructions or software that implement exemplary embodiments, for example, the modules illustrated in FIG. 3 (a sheet music line display module 1062, a key recognition module 1064, a musical notation display module 1066, an audio generator module 1068, and the like). In one embodiment, the storage device 1524 may store the audio signals generated by the audio generator module 1068 and the musical notations generated by the musical notation display module 1066.

The computing device 1500 may include a network interface 1512 configured to interface via one or more network devices 1322 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 1512 may include a built-in network adapter, network interface card, PCMCIA network card, card bus network adapter, wireless network adapter, USB network adapter, modem or any other device suitable for interfacing the computing device 1500 to any type of network capable of communication and performing the operations described herein. Moreover, the computing device 1500 may be any computer system, such as a workstation, desktop computer, server, laptop, handheld computer or other form of computing or telecommunications device that is capable of communication and that has sufficient processor power and memory capacity to perform the operations described herein.

The computing device 1500 may run any operating system 1516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. The operating system 1516 may be run in native mode or emulated mode. In an exemplary embodiment, the operating system 1516 may be run on one or more cloud machine instances.

Exemplary methods may also be implemented and executed on one or more embedded computing devices. The embedded computing device may be any suitable device incorporating electronics to control operational functions, and in which computing and networking capabilities are embedded. For example, devices in which the computing and networking capabilities may be embedded may include, but are not limited to, musical keyboard hardware equipment, audio-video equipment (e.g., audio and video recorders and players, televisions, digital cameras, digital video cameras, compact disks, digital video disks, camcorders, and the like), communication devices (e.g., telephones, cell phones, audio and video conferencing systems, the iPhone™ communication device, the iPad™ communication device, and the like), and the like.

In describing exemplary embodiments, specific terminology is used for the sake of clarity. For purposes of description, each specific term is intended to, at least, include all technical and functional equivalents that operate in a similar manner to accomplish a similar purpose. Additionally, in some instances where a particular exemplary embodiment includes a plurality of system elements or method steps, those elements or steps may be replaced with a single element or step. Likewise, a single element or step may be replaced with a plurality of elements or steps that serve the same purpose. Further, where parameters for various properties are specified herein for exemplary embodiments, those parameters may be adjusted up or down by 1/20th, 1/10th, ⅕th, ⅓rd, ½nd, and the like, or by rounded-off approximations thereof, unless otherwise specified. Moreover, while exemplary embodiments have been shown and described with references to particular embodiments thereof, those of ordinary skill in the art will understand that various substitutions and alterations in form and details may be made therein without departing from the scope of the invention. Further still, other aspects, functions and advantages are also within the scope of the invention.

1. A portable musical instrument, comprising:
a musical keyboard consisting of less than three octaves of keys, each key of which approximately corresponds in size, shape, weight, and frequency to a piano key, wherein the musical keyboard is configured to produce a signal characterizing a depression of any of its keys; and
a monitor configured to display piano staffs and musical notation corresponding to characteristics of the depression of keys of the musical keyboard, which musical notation may be derived from the signal produced by musical keyboard,
wherein the monitor is rotatably coupled to the musical keyboard such that the monitor has a use position in which the monitor forms an angle of at least about 90 degrees with respect to the keyboard and a storage position in which the monitor covers the musical keyboard and forms a portable unit including the musical keyboard.

2. The portable musical instrument of claim 1, further comprising at least one speaker configured to receive the audio signal from the musical keyboard and to produce sound.

3. The portable musical instrument of claim 1, further comprising a mechanism for adjusting the volume of the at least one speaker.

4. The portable musical instrument of claim 1, further comprising a headphone port configured to receive an audio signal from the musical keyboard.

5. The portable musical instrument of claim 4, wherein the at least one speaker does not produce sound when a headphone connector is inserted in the headphone port.

6. The portable musical instrument of claim 1, further comprising a mechanical device for holding sheet music such that it rests against the monitor while the monitor is in the use position.

7. The portable musical instrument of claim 1, wherein the monitor is configured to begin displaying musical notation corresponding to the depression of any of the keys of the musical keyboard shortly after the depression.

8. The portable musical instrument of claim 1, further comprising a memory device coupled to the musical keyboard, wherein the memory device is configured to store a representation of a musical notation describing a depression of a key of the musical keyboard shortly during and/or shortly after the depression.

9. The portable musical instrument of claim 1, further comprising a printer coupled to the musical keyboard, wherein the printer is configured to print of a musical notation whose representation is stored in the memory device.

10. The portable musical instrument of claim 1, further comprising a memory device coupled to the musical keyboard, wherein the memory device is configured to store a representation of the audio signal produced by the musical keyboard.

11. The portable musical instrument of claim 1, further comprising a rechargeable battery electrically coupled to the monitor and configured to power the portable musical instrument.

12. The portable musical instrument of claim 1, wherein depression of any key of the musical keyboard requires approximately the same force as depression of a corresponding piano key.

13. A portable musical instrument, comprising:
a musical keyboard having twenty-five keys, each key of which approximately corresponds in size, shape, and weight to a piano key, wherein the musical keyboard is configured to produce a signal characterizing a depression of any of its keys;
a monitor configured to display piano staffs and musical notation corresponding to the signal produced by the musical keyboard; and
a printer configured to print musical notation corresponding to the signal produced by the musical keyboard,
wherein the monitor is rotatably coupled to the musical keyboard such that the monitor has a use position in which the monitor forms an angle of at least about 90 degrees with respect to the keyboard and a storage position in which the monitor covers the musical keyboard and forms a portable unit including the musical keyboard and the printer.

14. The portable musical instrument of claim 13, further comprising at least one speaker configured to receive the audio signal from the musical keyboard and to produce sound.

15. The portable musical instrument of claim 13, further comprising a mechanism for adjusting the volume of the at least one speaker.

16. The portable musical instrument of claim 13, further comprising a headphone port configured to receive an audio signal from the musical keyboard.

17. The portable musical instrument of claim 16, wherein the at least one speaker does not produce sound when a headphone connector is inserted in the headphone port.

18. The portable musical instrument of claim 13, further comprising a memory device coupled to the musical keyboard, wherein the memory device is configured to store a representation of a musical notation describing a depression of a key of the musical keyboard shortly during and/or shortly after the depression.

19. The portable musical instrument of claim 13, wherein the printer is further configured to print of musical notation whose representation is stored in the memory device.

20. The portable musical instrument of claim 13, wherein depression of any key of the musical keyboard requires approximately the same force as depression of a corresponding piano key.
